(19) United States
(12) Patent Application Publication
(10) Pub. No.: US 2025/0267274 A1
(43) Pub. Date: Aug. 21, 2025

(54) UNI-DIRECTIONAL OPTICAL FLOW

(71) Applicant: Tencent America LLC, Palo Alto, CA (US)

(72) Inventors: Yonguk YOON, Palo Alto, CA (US); Lien-Fei CHEN, Palo Alto, CA (US); Biao WANG, San Jose, CA (US); Shan LIU, San Jose, CA (US); Motong XU, Palo Alto, CA (US); Roman CHERNYAK, Santa Clara, CA (US); Ziyue XIANG, Palo Alto, CA (US); Yifan WANG, Palo Alto, CA (US)

(73) Assignee: Tencent America LLC, Palo Alto, CA (US)

(21) Appl. No.: 19/035,686

(22) Filed: Jan. 23, 2025

Related U.S. Application Data
(60) Provisional application No. 63/682,272, filed on Aug. 12, 2024.
(60) Provisional application No. 63/555,614, filed on Feb. 20, 2024.

(51) Int. Cl. H04N 19/139; H04N 19/105; H04N 19/159; H04N 19/176; H04N 19/52

(52) U.S. Cl. CPC H04N 19/139; H04N 19/105; H04N 19/159; H04N 19/176; H04N 19/52

(57) ABSTRACT

In an example, a coded video bitstream is received. The coded video bitstream includes coded information of a current block in a current picture. The coded information is determined to indicate an inter prediction of the current block with at least a first reference picture and a second reference picture that are both on a same side of the current picture in a display order. To apply a uni-directional optical flow (UDOF) on at least a sample in the current block is determined. An optical flow motion vector to refine a motion vector of the sample is determined. The optical flow motion vector is derived based on the first reference picture and the second reference picture that are both on the same side of the current picture in the display order. At least the sample is reconstructed based on the optical flow motion vector.

### INCORPORATION BY REFERENCE

The present application claims the benefit of priority to U.S. Provisional Application No. 63/555,614, “UNI-DIRECTIONAL OPTICAL FLOW” filed on Feb. 20, 2024, and U.S. Provisional Application No. 63/682,272, “UNI-DIRECTIONAL OPTICAL FLOW” filed on Aug. 12, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a coded video bitstream is received. The coded video bitstream includes coded information of a current block in a current picture. The coded information is determined to indicate an inter prediction of the current block with at least a first reference picture and a second reference picture that are both on a same side of the current picture in a display order. To apply a uni-directional optical flow (UDOF) on at least a sample in the current block is determined. An optical flow motion vector to refine a motion vector of the sample is determined. The optical flow motion vector is derived based on the first reference picture and the second reference picture that are both on the same side of the current picture in the display order. At least the sample is reconstructed based on the optical flow motion vector.

Some aspects of the disclosure provide a method for video encoding. In an example, to apply a uni-directional optical flow (UDOF) on at least a sample in a current block of a current picture is determined. The current block is an inter prediction block with at least a first reference picture and a second reference picture that are both on a same side of the current picture in a display order. An optical flow motion vector that refines a motion vector of the sample is derived. The optical flow motion vector is derived based on the first reference picture and the second reference picture that are both on the same side of the current picture in the display order. At least the sample is encoded based on the optical flow motion vector.

Some aspects of the disclosure provide a method of processing visual media data is provided. In the method, a conversion between a visual media file and a bitstream of visual media data is performed according to a format rule. In an example, the bitstream includes coded information of a current block in a current picture, the coded information of the current block indicates an inter prediction of the current block with at least a first reference picture and a second reference picture that are both on a same side of the current picture in a display order. The format rule specifies that: to apply a uni-directional optical flow (UDOF) on at least a sample in the current block is determined; an optical flow motion vector that refines a motion vector of the sample is derived based on the first reference picture and the second reference picture that are both on the same side of the current picture in the display order; and at least the sample is reconstructed based on the optical flow motion vector.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a diagram for bi-directional optical flow (BDOF) in some examples.

FIG. 5 shows a diagram of a chained motion vector in some examples.

FIG. 6 shows a diagram of uni-directional optical flow of forward direction in some examples.

FIG. 7 shows a diagram of uni-directional optical flow of backward direction in some examples.

FIG. 8 shows a diagram of coding scenario for using uni-directional optical flow in some examples.

FIG. 9 shows a diagram of uni-directional optical flow in some examples.

FIG. 10 shows a diagram of uni-directional optical flow of forward direction in some examples.

FIG. 11 shows a diagram of uni-directional optical flow of backward direction in some examples.

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

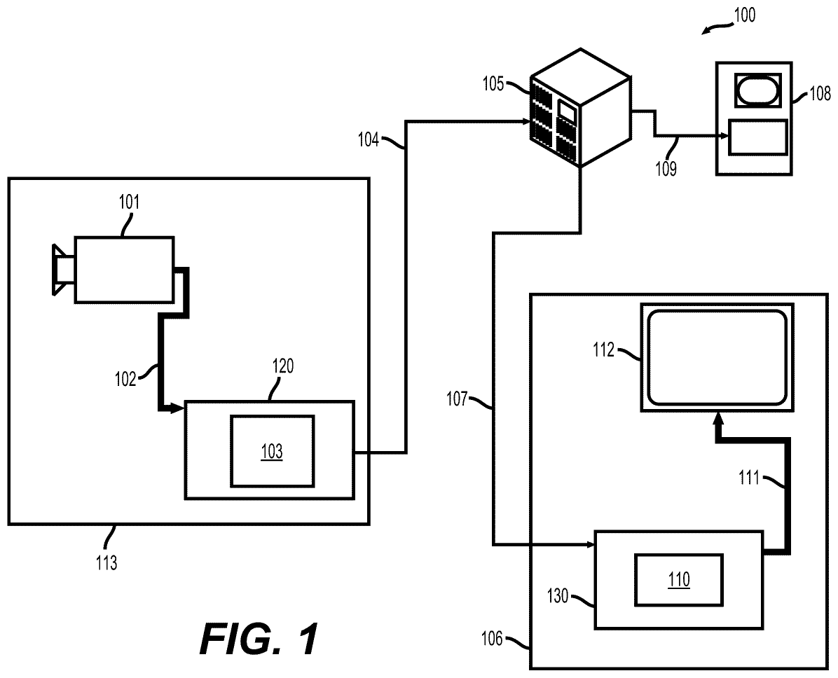

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

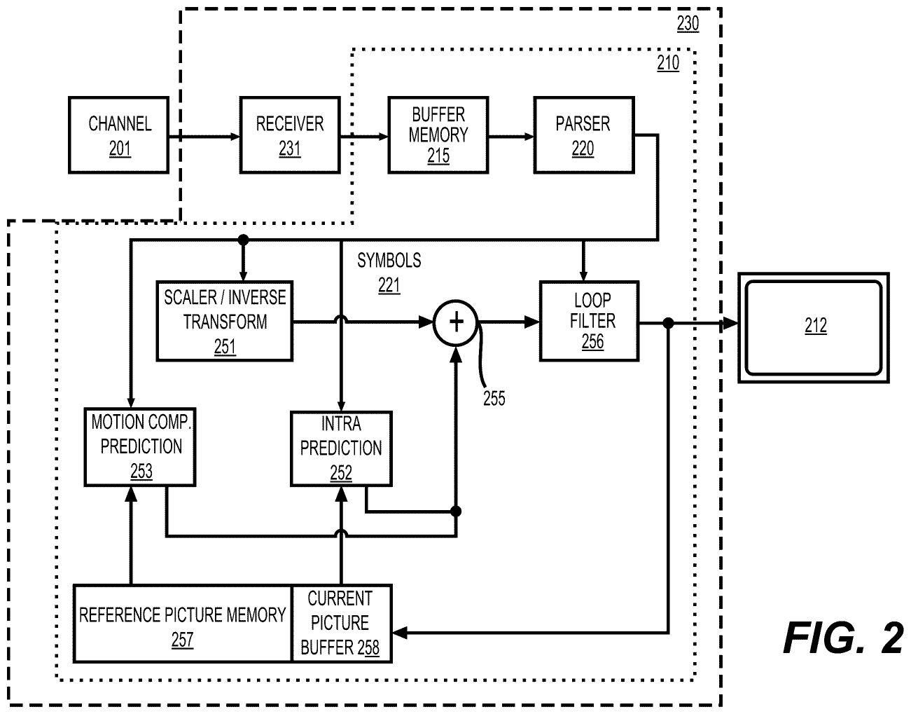

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

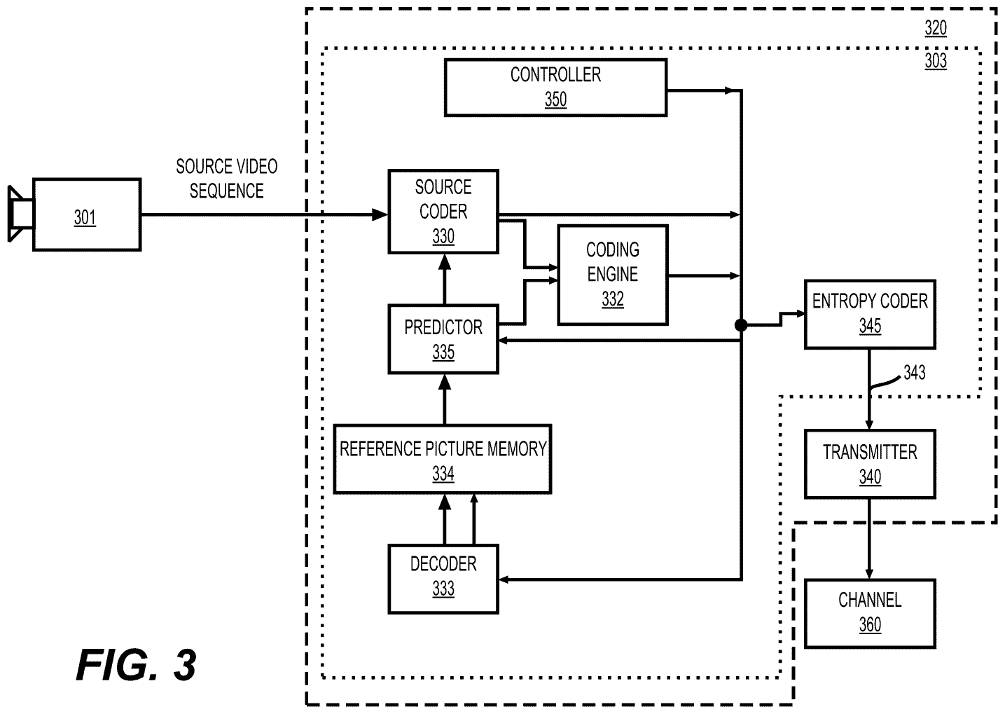

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques (e.g., methods, embodiments, encoders, decoders) for uni-directional prediction refinement method using optical flow. The techniques in the present disclosure may be used separately or combined in any order. Further, each of the techniques may be implemented by processing circuitry (e.g., one or more processors or one or more integrated circuits). In one example, the one or more processors execute a program that is stored in a non-transitory computer-readable medium.

Video coding has been widely used in many applications. Video coding standards, such as H264, H265, H266 (VVC), AV 1 and AVS, can be adopted in video codec for video coding.

A video codec generally includes several modules, including intra/inter prediction, transform coding, quantization, entropy coding and in loop filtering, etc. Some aspects of the present disclosure provide a set of methods for video compression in the inter prediction coding. In inter prediction coding, in some examples, a bi-directional prediction block is further refined by optical flow. The technique to refine bi-directional prediction block using optical flow is referred to as bi-directional optical flow (BDOF). The BDOF is used to refine either the motion vector or the prediction signal which is constructed by bi-directional prediction.

According to some aspects of the disclosure, the BDOF technique is based on an assumption that a prediction block (of a current block in a current picture) between two directional prediction blocks (in respective reference pictures) has brightness constancy, such as represented by an optical flow equation in Eq. (1):

$$Optical flow equation : \frac{\partial I}{\partial x} {v}_{x} + \frac{\partial I}{\partial y} {v}_{y} + \frac{\partial I}{\partial t} = 0 \qquad Eq . ( 1 )$$

According to an aspect of the disclosure, optical flow motion vector can be derived from the optical flow equation. Then, using derived optical flow motion vector, either the motion vector or the prediction signal can be refined.

According to an aspect of the disclosure, BDOF is used to refine either the motion vector or the prediction signal which is constructed by bi-directional prediction.

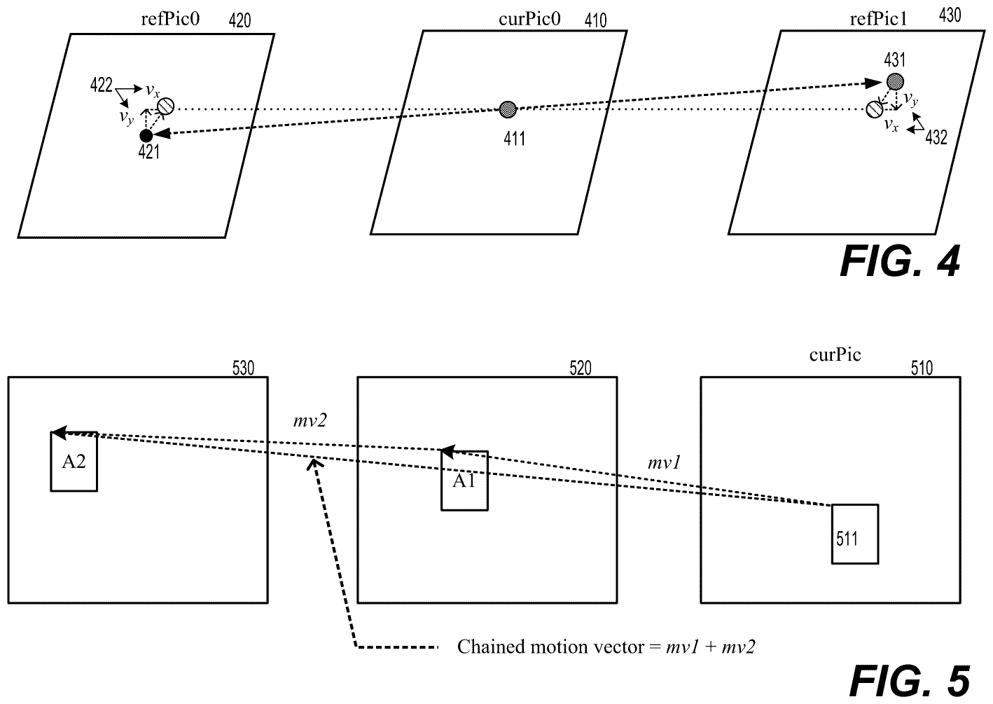

FIG. 4 shows a diagram for BDOF in some examples. In the FIG. 4 example, a current picture (410) in a video has a first reference picture (420) and a second reference picture (430) for bi-prediction. The first reference picture (420) is after the current picture (410) in the display order and the second reference picture (430) is before the current picture (410) in the display order. For simplicity reasons, object motions are assumed to be symmetric and equal in value, and BDOF is applied for equal L0 and L1 picture order count (POC) distances.

In the FIG. 4 example, among the first reference picture (420), the current picture (410) and the second reference picture (430), objects can be assumed to move with constant speed, therefore, the so-called “steady motion” model can be employed. Further, objects' luminance does not change, so optical flow partial differential equation (e.g., Eq. (1)) is valid. In some aspects, fine motion may be lost using the standard block-based bi-prediction. Then, the differential optical flow equation can be used to derive motion refinement (vₓ, v_{y}) (also referred to as optical flow motion vector or optical flow motion refinement). For example, using a standard block-based bi-prediction, a sample (411) in the current picture (410) has a first reference sample (421) in the first reference picture (420) and has a second reference sample (431) in the second reference picture (430). When BDOF is applied, the motion refinement (vₓ, v_{y}) can be determined, such as shown by (422) and (432) in FIG. 4. Then, the sample (411) in the current picture (410) can be predicted based on the first reference sample (421), the second reference sample (431) and the motion refinement (vₓ, v_{y}).

In some examples, BDOF can be used to refine a bi-prediction signal of a CU at a 4×4 subblock level. BDOF can be applied to a CU if the CU satisfies conditions (also referred to as requirement for BDOF, or a set of conditions for BDOF) as follows:
(1) The CU is coded using “true” bi-prediction mode, i.e., one of the two reference pictures is prior to the current picture in display order and the other is after the current picture in display order,
(2) The distances (e.g., picture order count (POC) difference) from two reference pictures to the current picture are the same,
(3) Both reference pictures are short-term reference pictures,
(4) The CU is not coded using affine mode or the SbTMVP merge mode,
(5) CU has more than 64 luma samples,
(6) Both CU height and CU width are larger than or equal to 8 luma samples,
(7) BCW weight index indicates equal weight,
(8) Weighted prediction (WP) is not enabled for the current CU, and
(9) CIIP mode is not used for the current CU.

In some examples, BDOF is only applied to a luma component. As the name of BDOF indicates, the BDOF mode can be based on an optical flow concept, which assumes that a motion of an object is smooth. For each 4×4 subblock, a motion refinement (vₓ, v_{y}) can be calculated by minimizing a difference between L0 and L1 prediction samples. The motion refinement can then be used to adjust the bi-predicted sample values in the 4×4 subblock. BDOF can include steps as follows.

First, horizontal and vertical gradients,

$$\frac{\partial {I}^{( k )}}{\partial x} ( i , j ) and \frac{\partial {I}^{( k )}}{\partial y} ( i , j ) ,$$

k=0, 1, of the two prediction signals from the reference list L0 and the reference list L1 can be computed by directly calculating a difference between two neighboring samples. The horizontal and vertical gradients can be provided in Eq. (2) and Eq. (3) as follows:

$$\frac{\partial {I}^{( k )}}{\partial x} ( i , j ) = ( ( {I}^{( k )} ( i + 1 , j ) ) shift 1 ) - ( {I}^{( k )} ( i - 1 , j ) ) shift 1 ) ) \qquad Eq . ( 2 )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) ) \qquad Eq . ( 3 )$$

where I^{(k)}(i,j) can be a sample value at coordinate (i,j) of the prediction signal in list k, k=0,1, and shift1 can be calculated based on a luma bit depth, bitDepth, as shift1=max (6, bitDepth−6).

Then, auto- and cross-correlation of the gradients, S₁, S₂, S₃, S₅ and S₆, can be calculated according to Eqs. (4)-(8) as follows:

$${S}_{1} = {\sum }_{( i , j ) ∈ Ω} Abs ( {ψ}_{x} ( i , j ) ) \qquad Eq . ( 4 )$$

$${S}_{2} = {\sum }_{( i , j ) ∈ Ω} {ψ}_{x} ( i , j ) \cdot Sign ( {ψ}_{y} ( i , j ) ) \qquad Eq . ( 5 )$$

$${S}_{3} = {\sum }_{( i , j ) ∈ Ω} θ ( i , j ) \cdot Sign ( {ψ}_{x} ( i , j ) ) \qquad Eq . ( 6 )$$

$${S}_{5} = {\sum }_{( i , j ) ∈ Ω} Abs ( {ψ}_{y} ( i , j ) ) \qquad Eq . ( 7 )$$

$${S}_{6} = {\sum }_{( i , j ) ∈ Ω} θ ( i , j ) \cdot Sign ( {ψ}_{y} ( i , j ) ) \qquad Eq . ( 8 )$$

where ψₓ(i,j), ψ_{y}(i,j), and θ(i,j) can be provided in Eq. (9)-(11) respectively.

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad Eq . ( 9 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \qquad Eq . ( 10 )$$

$$θ ( i , j ) = ( {I}^{( 1 )} ( i , j ) ≫ {n}_{b} ) - ( {I}^{( 0 )} ( i , j ) ≫ {n}_{b} ) \qquad Eq . ( 11 )$$

where Ω can be a 6×6 window around the 4×4 subblock, and the values of nₐ and n_{b} can be set equal to min (1, bitDepth−11) and min (4, bitDepth−8), respectively.

The motion refinement (vₓ, v_{y}) can then be derived using the cross- and auto-correlation terms using Eqs. (12) and (13) as follows:

$$Eq . ( 12 )$$

$${v}_{x} = {S}_{1} > 0 ? clip 3 ( - t {h}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0$$

$$Eq . ( 13 )$$

$${v}_{y} = {S}_{5} > 0 ? clip 3 ( - t {h}_{BIO}^{′} , t {h}_{BIO ,}^{′} - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 s} ) / 2 ) ≫ ⌊ {log}_{2} {S}_{5} ⌋ ) ) : 0$$

where S_{2,m}=S₂>>n_{S}_{₂}, S_{2,s}=S₂& (2ⁿ^{ₛ₂}−1), th′_{BIO}=2^{max(5,BD-7)}. └⋅┘ is a floor function, and nₛ_{₂}=12. Based on the motion refinement and the gradients, an adjustment can be calculated for each sample in the 4×4 subblock based on Eq. (14):

$$b ( x , y ) = rnd ( \frac{( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 )}{2} ) \qquad Eq . ( 14 )$$

Finally, the BDOF samples of the CU can be calculated by adjusting the bi-prediction samples in Eq. (15) as follows:

$$Eq . ( 15 )$$

$$p r e {d}_{B D O F} ( x , y ) = ( {I}^{( 0 )} ( x , y ) + {I}^{( 1 )} ( x , y ) + b ( x , y ) + {0}_{offset} ) ≫ shift$$

In some examples, values can be selected such that multipliers in the BDOF process do not exceed 15-bits, and a maximum bit-width of the intermediate parameters in the BDOF process can be kept within 32-bits.

In some examples, sample based BDOF can be used instead of a block based BDOF. In the sample-based BDOF, instead of deriving motion refinement (vₓ, v_{y}) on a block basis, the motion refinement can be performed per sample. The coding block is divided into 8×8 subblocks. For each subblock, whether to apply BDOF or not is determined by checking the SAD between the two reference subblocks against a threshold. When it is decided to apply BDOF to a subblock, for every sample in the subblock, a sliding 5×5 window is used and the BDOF process is applied for every sliding window to derive vₓ and v_{y}. The derived motion refinement (vₓ, v_{y}) is applied to adjust the bi-predicted sample value for the center sample of the window.

Some aspects of the disclosure provide techniques for uni-directional optical flow. For example, when a current block in a current picture is an inter prediction block with at least a first reference picture and a second reference picture that are both on a same side of the current picture in a display order, a uni-directional optical flow (UDOF) can be applied on at least a sample in the current block. Encoder/decoder can derive an optical flow motion vector that refines a motion vector of the sample. The optical flow motion vector is derived based on the first reference picture and the second reference picture that are both on the same side of the current picture in the display order.

In some examples, the techniques can be used on a scenario of a chained motion vector. A chained motion vector refers to a motion vector chain which including at least two motion vectors in a sequence, such as a first motion vector and a second motion vector in a sequence.

FIG. 5 shows a diagram of a chained motion vector in some examples. In the FIG. 5 example, a current block (511) in a current picture (510) of a video has a first reference block A1 in a first reference picture (520) that is pointed by a first motion vector (mv1) based on the current block (511); and the first reference block A1 in the first reference picture (520) has a second reference block A2 in a second reference picture (530) that is pointed by a second motion vector (mv2) based on the first reference block A1. The first reference picture (520) and the second reference picture (530) are on a same side of the current picture (510) in the display order. In an example, both the first reference picture (520) and the second reference picture (530) are before the current picture in the picture sequence of the video (also referred to as forward direction of uni-directional optical flow) or both the first reference picture (520) and the second reference picture (530) are after the current picture in the display order (also referred to as backward direction of uni-directional optical flow). In the FIG. 5 example, a combination of the first motion vector (mv1) and the second motion vector (mv2) forms a chained motion vector.

According to some aspects of the disclosure, when chained motion vector is used, the current block (511) can be similar to both the first reference block A1 and the second reference block A2. The current block (511) can be refined using optical flow motion refinement that is derived based on the first reference block A1 and the second reference block A2 using uni-directional optical flow (UDOF).

According to some aspects of the disclosure, UDOF is used to refine either a motion vector or a prediction block when predicted by a chained motion vector. In some examples, optical flow motion vector (vₓ, v_{y}) (also referred to as optical flow motion refinement) is derived using two reference blocks of the chained motion vector. For the motion refinement, derived optical flow motion vector is added to the original motion vector. For the prediction signal refinement, two different prediction signals from the reference blocks (e.g., the first reference block A1 and the second reference block A2) are combined with uni-directional optical flow offset as a final uni-directional optical flow prediction signal.

In some aspects, the current block can have at least one or more chained motion vector.

In some examples, the chained motion vector includes more than one motion vector in a chain.

In some examples, the optical flow motion vector can be derived from optical flow equation in a similar manner as BDOF.

In some examples, the final UDOF motion vector depends on the prediction directions and the distance between the current picture and reference pictures (e.g., the first reference picture and the second reference picture).

In an example, the final UDOF motion vector can be refined depending on the direction, such as forward direction of the UDOF or backward direction of the UDOF.

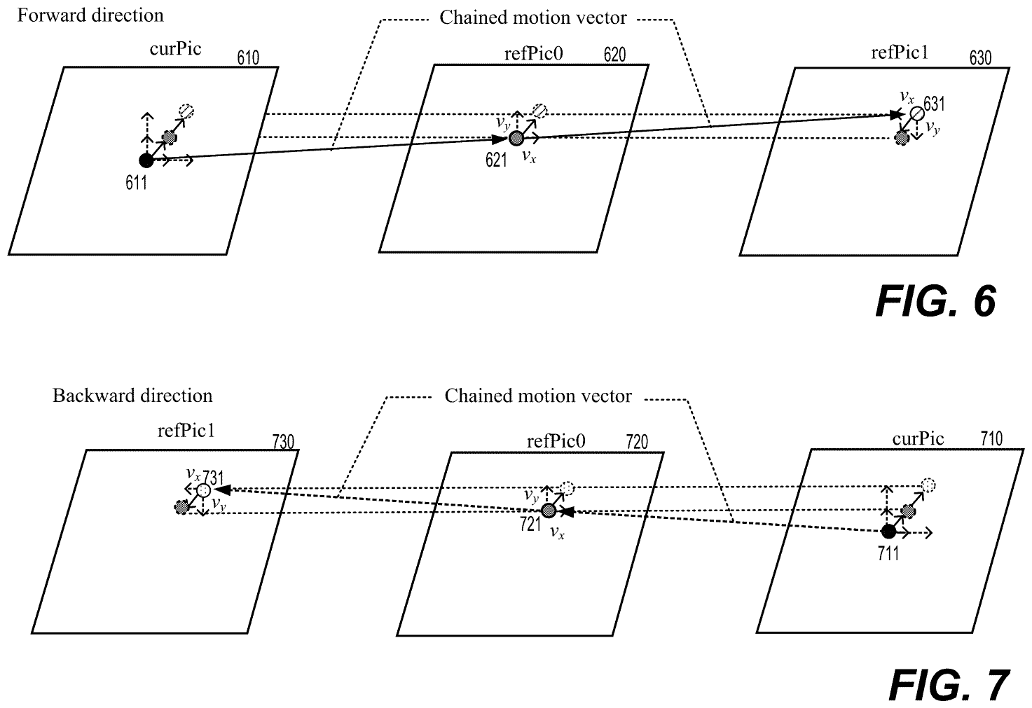

FIG. 6 shows a diagram of uni-directional optical flow of forward direction in some examples. In the FIG. 6 example, a first reference picture (620) is before a current picture (610), and a second reference picture (630) is before the first reference picture (620) in the picture sequence of the video. In the FIG. 6 example, based on a chained motion vector, a sample (611) in the current picture (610) has a first reference sample (621) in the first reference picture (620); and the first reference sample (621) in the first reference picture (620) has a second reference sample (631) in the second reference picture (630) based on the chained motion vector. Further, in the FIG. 6 example, optical flow motion refinement (vₓ, v_{y}) can be derived based on the first reference picture (620) and the second reference picture (630) (e.g., based on the first reference sample (621) with neighboring samples, and the second reference sample (631) with neighboring samples). Then, the motion vector for the sample (611) can be refined based on the optical flow motion refinement (vₓ, v_{y}).

In some examples, for the forward direction, the final UDOF motion vector (mvx_{udof}, mvy_{udof}) can be refined according to Eq. (16) and Eq. (17):

$$m v {x}_{udof} = m v x - a \cdot {v}_{x} \qquad Eq . ( 16 )$$

$$mv {y}_{udof} = m v y - a \cdot {v}_{y} \qquad Eq . ( 17 )$$

where motion vector (mvx, mvy) denote predicted motion vector; a denotes a scale factor depending on the distance between the current picture and reference pictures. Optical flow motion vector (vₓ, v_{y}) is derived from optical flow equation based on the reference pictures. Optical flow motion vector (vₓ, v_{y}) is also referred to as motion refinement, or optical flow motion refinement in some examples.

FIG. 7 shows a diagram of uni-directional optical flow of backward direction in some examples. In the FIG. 7 example, a first reference picture (720) is after a current picture (710), and a second reference picture (730) is after the first reference picture (720) in the picture sequence of the video (e.g., in a display order). In the FIG. 7 example, based on a chained motion vector, a sample (711) in the current picture (710) has a first reference sample (721) in the first reference picture (720); and the first reference sample (721) in the first reference picture (720) has a second reference sample (731) in the second reference picture (730) based on the chained motion vector. Further, in the FIG. 7 example, optical flow motion refinement (vₓ, v_{y}) can be derived based on the first reference picture (720) and the second reference picture (730) (e.g., based on the first reference sample (721) with neighboring samples, and the second reference sample (731) with neighboring samples). Then, the motion vector for the sample (711) can be refined based on the optical flow motion refinement (vₓ, v_{y}).

In some examples, for backward direction, the final UDOF motion vector (mvx_{udof}, mvy_{udof}) can be refined according to Eq. (18) and Eq. (19):

$$m v {x}_{udof} = m v x + a \cdot {v}_{x} \qquad Eq . ( 18 )$$

$$mv {y}_{udof} = m v y + a \cdot {v}_{y} \qquad Eq . ( 19 )$$

where motion vector (mvx, mvy) denote predicted motion vector; a denotes a scale factor depending on the distance between the current picture and reference pictures. Optical flow motion vector (vₓ, v_{y}) is derived from optical flow equation. Optical flow motion vector (vₓ, v_{y}) is also referred to as motion refinement in some examples.

In some examples, the final UDOF prediction signal depends on the prediction directions and the distance between the current picture and reference pictures.

In an example, the final prediction signal can be generated depending on direction as below. For example, for forward direction, the final prediction signal is calculated according to Eq. (20); for backward direction, the final prediction signal is calculated according to Eq. (21); the gradient Iₓ^{k} and I_{y}^{k} can be calculated according to Eq. (22) and Eq. (23):

$$pred = \frac{{I}^{0} + {I}^{1}}{2} + \frac{1}{2} ( {v}_{x} ( {w}_{0} \cdot {I}_{x}^{0} + {w}_{1} \cdot {I}_{x}^{1} ) + {v}_{y} ( {w}_{0} \cdot {I}_{y}^{0} + {w}_{1} \cdot {I}_{y}^{1} ) ) \qquad Eq . ( 20 )$$

$$pred = \frac{{I}^{0} + {I}^{1}}{2} - \frac{1}{2} ( {v}_{x} ( {w}_{0} \cdot {I}_{x}^{0} + {w}_{1} \cdot {I}_{x}^{1} ) + {v}_{y} ( {w}_{0} \cdot {I}_{y}^{0} + {w}_{1} \cdot {I}_{y}^{1} ) ) \qquad Eq . ( 21 )$$

$${I}_{x}^{k} ( x , y ) = {I}^{k} ( x + 1 , y ) - {I}^{k} ( x - 1 , y ) \qquad Eq . ( 22 )$$

$${I}_{y}^{k} ( x , y ) = {I}^{k} ( x , y + 1 ) - {I}^{k} ( x , y - 1 ) \qquad Eq . ( 23 )$$

where I⁰ and I¹ denote the predictor from the first motion vector and second motion vector of chained motion vector, respectively. Iₓ⁰ and I_{y}⁰ denote horizontal and vertical gradients of the nearest reference picture (e.g., first reference picture) from the current picture. Iₓ¹ and I_{y}¹ denote horizontal and vertical gradients of the second reference picture. The weights w₀ and w₁ depend on the distance between the current picture and reference pictures.

In another example, when the direction is forward direction and the distance between the current picture and the second reference picture is two times of the distance between the current picture and the first reference picture, the final prediction is generated according to Eq. (24). In this case, the weights (w₀, w₁) are (1, 2).

$$pred = \frac{{I}^{0} + {I}^{1}}{2} + \frac{1}{2} ( {v}_{x} ( {I}_{x}^{0} + 2 \cdot {I}_{x}^{1} ) + {v}_{y} ( {I}_{y}^{0} + 2 \cdot {I}_{y}^{1} ) ) \qquad Eq . ( 24 )$$

In another example, when the direction is backward and the distance between the current picture and second reference picture is two times of the distance between the current picture and first reference picture, the final prediction is generated according to Eq. (25). In this case, the weights (w₀, w₁) are (1, 2).

$$pred = \frac{{I}^{0} + {I}^{1}}{2} - \frac{1}{2} ( {v}_{x} ( {I}_{x}^{0} + 2 \cdot {I}_{x}^{1} ) + {v}_{y} ( {I}_{y}^{0} + 2 \cdot {I}_{y}^{1} ) ) \qquad Eq . ( 25 )$$

In some examples, UDOF can be applied in the unit of at least one of sample-wise, sub-block, and block. In an example, UDOF is applied sample by sample. In another example, UDOF is applied sub-block by sub-block. In another example, UDOF is applied CU by CU.

In some examples, UDOF can be applied according to block shape, block size, and other coding information. For example, when the block size is smaller than 4×4, UDOF is not applied.

In some examples, whether UDOF is applied can be determined when the difference between reference blocks is compared with a specified threshold. In an example, when the sum of absolute difference (SAD) cost of corresponding samples of the reference blocks is larger than the specified threshold, the UDOF is not to applied.

In another example, when the sum of absolute difference (SAD) cost between the two reference blocks (pointed by the first motion vector and the second motion vector within the chained motion vector) is smaller than specified threshold, UDOF is not applied.

In some examples, when either width or height of the current block is larger than N samples, the width and/or height of the current block can be split based on N samples. For example, when the current block size is 32×32 and N is 16, the current block can be split into 4 UDOF processing units, and each UDOF processing unit is 16×16. Further, each UDOF processing unit can be individually determined to apply or not to apply the UDOF. In some examples, whether to apply UDOF on a UDOF processing unit is determined according to the cost of reference blocks of each UDOF processing unit. In an example, the cost is calculated to indicate at least one of prediction accuracy by UDOF and complexity by UDOF.

The present disclosure also provides techniques for uni-directional optical flow in scenarios other than the chained motion vector scenario. In some examples, uni-directional prediction blocks can have the uni-directional motion vectors follow the same motion trajectory while maintaining brightness constancy. The techniques for unidirectional optical flow can refine motion vectors and improve accuracy of the prediction block.

In some examples, uni-directional optical flow (UDOF) is utilized to refine either motion vectors or a prediction block.

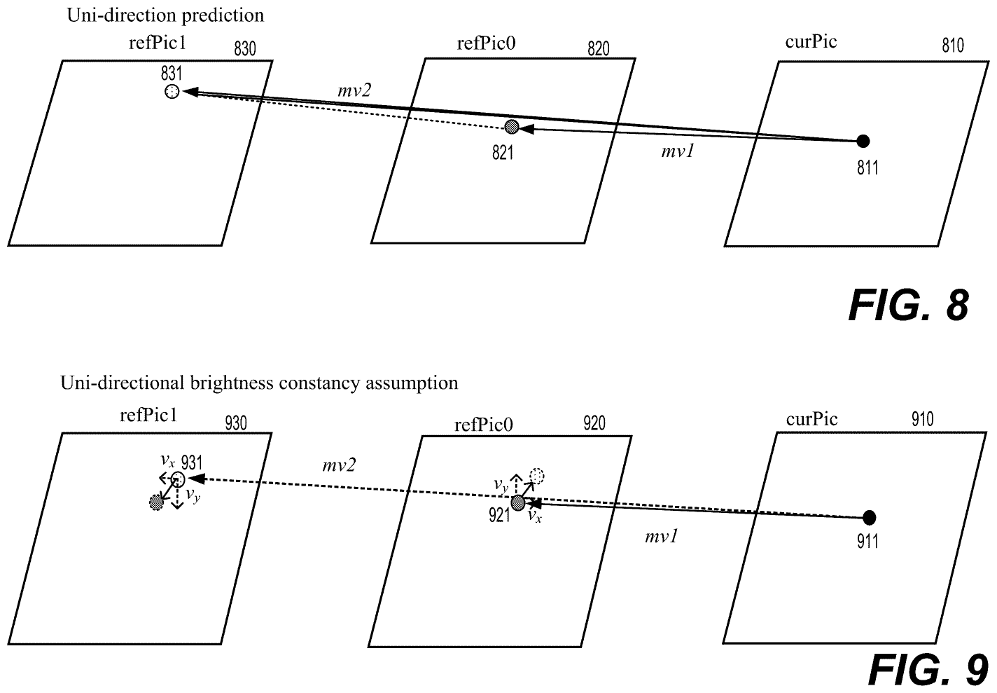

FIG. 8 shows a diagram of coding scenario for using uni-directional optical flow in some examples. In the FIG. 8 example, a sample (811) in a current picture (810) of a video has a first reference sample (821) in a first reference picture (820) that is pointed by a first motion vector (mv1) based on the sample (811); and has a second reference sample (831) in a second reference picture (830) that is pointed by a second motion vector (mv2) based on the sample (811). It is noted that the first motion vector and the second motion in the FIG. 8 example do not form a chained motion vector. The first reference picture (820) and the second reference picture (830) are on a same side of the current picture (810) in the display order. In an example, both the first reference picture (820) and the second reference picture (830) are before the current picture in the display order (also referred to as forward direction of uni-directional optical flow) or both the first reference picture (820) and the second reference picture (830) are after the current picture in the display order (also referred to as backward direction of uni-directional optical flow).

According to some aspects of the disclosure, the sample (811) can be predicted using two motion vectors that associated with reference pictures on a same side of the current reference picture. For example, the sample (811) can be predicted using the two motion vectors, such as according to the first reference sample (821) and the second reference sample (831). The prediction of the sample (811) can be refined using optical flow using uni-directional optical flow (UDOF).

FIG. 9 shows a diagram of uni-directional optical flow in some examples. In the FIG. 9 example, a first reference picture (920) and a second reference picture are at a same side of a current picture (910) in the display order. In the FIG. 9 example, a sample (911) in the current picture (910) can be predicted by a first motion vector (mv1) pointing to a first reference sample (921) in the first reference picture (920), and/or can be predicted by a second motion vector (mv2) pointing to a second reference sample (931) in the second reference picture (930). Further, in the FIG. 9 example, optical flow motion refinement (vₓ, v_{y}) can be derived based on the first reference picture (920) and the second reference picture (930) (e.g., based on the first reference sample (921) with neighboring samples, and the second reference sample (931) with neighboring samples). Then, the motion vector for the sample (911) can be refined based on the optical flow motion refinement (vₓ, v_{y}).

In the FIG. 9 example, to apply uni-directional optical flow, the motion vectors are assumed to maintain brightness constancy by following the same trajectory.

In some examples, optical flow motion vector (vₓ, v_{y}) (also referred to as optical flow motion refinement) is derived by minimizing the difference between two sets of samples in the two reference pictures. In an example, the two sets of samples can include a first set of samples in a first reference block in the first reference picture, a second set of samples in a second reference block in the second reference picture. In another example, the two sets of samples can include a first set of samples in a first window that covers the first reference sample in the first reference picture, a second set of samples in a second window that covers the second reference sample in the second reference picture. In an example, the optical flow motion vector (vₓ, v_{y}) is derived according to Eq. (26):

$$( {v}_{x} {v}_{y} ) = {min}_{{v}_{x} , {v}_{y}} {\sum }_{[ i , j ] ∈ Ω} {Δ}^{2} [ i , j ] , Δ = {I}^{0} - {I}^{1} \qquad Eq . ( 26 )$$

where Iⁿ represents the reference samples from reference picture n. [i, j] denotes the coordinates within a window Ω. In some examples, based on the assumption that brightness changes are the same for I⁰→I¹ and I¹→I⁰, A is derived using two optical flow equations and can be solved using the least mean square method, such as according to Eq. (27)-Eq. (32):

$${I}^{0} \to {I}^{1} : \frac{\partial {I}^{0}}{\partial x} {v}_{x} + \frac{\partial {I}^{0}}{\partial y} {v}_{y} + \frac{\partial I}{\partial t} = 0 \qquad Eq . ( 27 )$$

$${I}^{1} \to {I}^{0} : - \frac{\partial {I}^{1}}{\partial x} {v}_{x} - \frac{\partial {I}^{1}}{\partial y} {v}_{y} - \frac{\partial I}{\partial t} = 0 \qquad Eq . ( 28 )$$

$$Δ = - \frac{\partial I}{\partial t} = - {I}_{t} = \frac{1}{2} ( ( \frac{\partial {I}^{0}}{\partial x} {v}_{x} + \frac{\partial {I}^{0}}{\partial y} {v}_{y} ) + ( \frac{\partial {I}^{1}}{\partial x} {v}_{x} + \frac{\partial {I}^{1}}{\partial y} {v}_{y} ) ) \qquad Eq . ( 29 )$$

$$- {I}_{t} = \frac{1}{2} ( ( \frac{\partial {I}^{0}}{\partial x} + \frac{\partial {I}^{1}}{\partial x} ) {v}_{x} + ( \frac{\partial {I}^{0}}{\partial y} + \frac{\partial {I}^{1}}{\partial y} ) {v}_{y} ) \approx {I}_{x} {v}_{x} + {I}_{y} {v}_{y} \qquad Eq . ( 30 )$$

$$[ \begin{matrix}{I}_{x} & {I}_{y}\end{matrix} ] [ \begin{matrix}{v}_{x} \\ {v}_{y}\end{matrix} ] = - {I}_{t} \qquad Eq . ( 31 )$$

$$[ \begin{matrix}{I}_{x} {I}_{x} & {I}_{x} {I}_{y} \\ {I}_{x} {I}_{y} & {I}_{y} {I}_{y}\end{matrix} ] [ \begin{matrix}{v}_{x} \\ {v}_{y}\end{matrix} ] = − [ \begin{matrix}{I}_{x} {I}_{t} \\ {I}_{y} {I}_{t}\end{matrix} ] \qquad Eq . ( 32 )$$

wherein Iₓ is the horizontal gradient, I_{y} is the vertical gradient.

According to some aspects of the disclosure, the derived optical flow motion vector (vₓ, v_{y}) can be used to refine motion vector and the prediction block of the current block in some examples.

In some aspects, the motion vector of the current block can be refined by adding the derived optical flow motion vector to generate the final UDOF motion vector.

In some examples, the final UDOF motion vector can be refined depending on the prediction directions and the distance between the current picture and reference pictures.

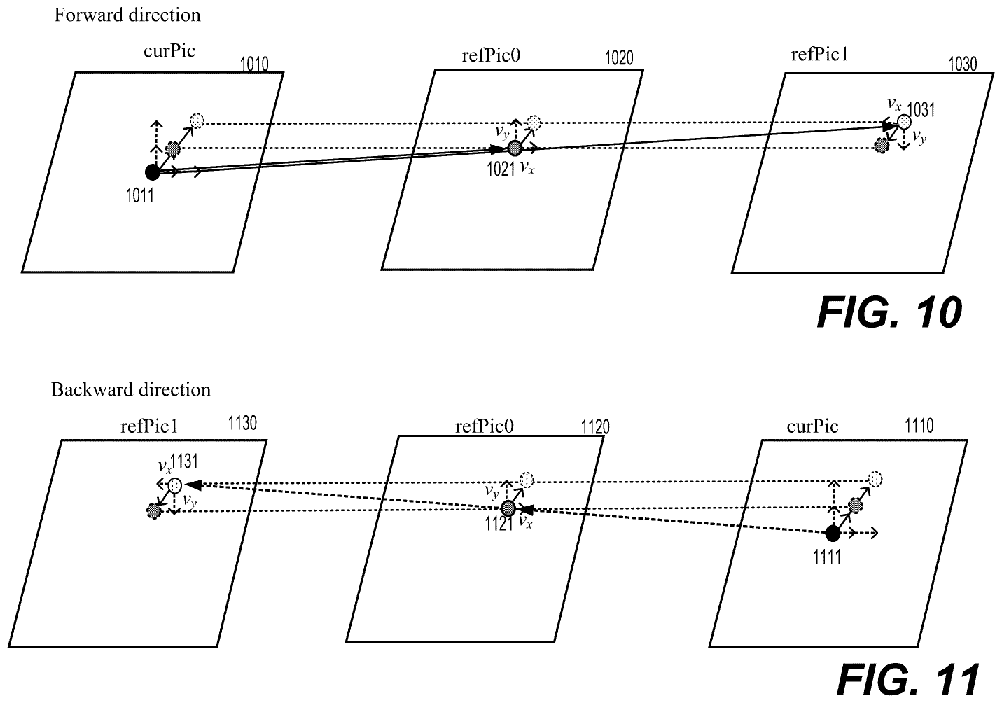

FIG. 10 shows a diagram of uni-directional optical flow of forward direction in some examples. In the FIG. 10 example, a first reference picture (1020) is before a current picture (1010), and a second reference picture (1030) is before the first reference picture (1020) in the picture sequence of the video (e.g., in a display order). In the FIG. 10 example, a sample (1011) in the current picture (1010) has a first reference sample (1021) in the first reference picture (1020) based on a first motion vector, and also has a second reference sample (1031) in the second reference picture (1030) based on a second motion vector. Further, in the FIG. 10 example, optical flow motion refinement (vₓ, v_{y}) can be derived based on the first reference picture (1020) and the second reference picture (1030) (e.g., based on the first reference sample (1021) with neighboring samples, and the second reference sample (1031) with neighboring samples). Then, the motion vector for the sample (1011) can be refined based on the optical flow motion refinement (vₓ, v_{y}).

In some examples, for the forward direction, the final UDOF motion vector (mvx_{udof}, mvy_{udof}) can be refined according to Eq. (33) and Eq. (34):

$$m v {x}_{udof} = m v x - a \cdot {v}_{x} \qquad Eq . ( 33 )$$

$$mv {y}_{udof} = m v y - a \cdot {v}_{y} \qquad Eq . ( 34 )$$

where motion vector (mvx, mvy) denote predicted motion vector; a denotes a scale factor depending on the distance between the current picture and reference pictures. Optical flow motion vector (vₓ, v_{y}) is derived from optical flow equation based on the reference pictures. Optical flow motion vector (vₓ, v_{y}) is also referred to as motion refinement in some examples.

FIG. 11 shows a diagram of uni-directional optical flow of backward direction in some examples. In the FIG. 11 example, a first reference picture (1120) is after a current picture (1110), and a second reference picture (1130) is after the first reference picture (1120) in the picture sequence of the video. In the FIG. 11 example, a sample (1111) in the current picture (1110) has a first reference sample (1121) in the first reference picture (1120); and also has a second reference sample (1131) in the second reference picture (1130). Further, in the FIG. 11 example, optical flow motion refinement (vₓ, v_{y}) can be derived based on the first reference picture (1120) and the second reference picture (1130) (e.g., based on the first reference sample (1121) with neighboring samples, and the second reference sample (1131) with neighboring samples). Then, the motion vector for the sample (1111) can be refined based on the optical flow motion refinement (vₓ, v_{y}).

In some examples, for backward direction, the final UDOF motion vector (mvx_{udof}, mvy_{udof}) can be refined according to Eq. (35) and Eq. (36):

$$m v {x}_{udof} = m v x + a \cdot {v}_{x} \qquad Eq . ( 35 )$$

$$mv {y}_{udof} = m v y + a \cdot {v}_{y} \qquad Eq . ( 36 )$$

where motion vector (mvx, mvy) denote predicted motion vector; a denotes a scale factor depending on the distance between the current picture and reference pictures. Optical flow motion vector (vₓ, v_{y}) is derived from optical flow equation. Optical flow motion vector (vₓ, v_{y}) is also referred to as motion refinement in some examples.

In some examples, the final UDOF prediction signal depends on the prediction directions and the distance between the current picture and reference pictures.

In an example, the final prediction signal can be generated depending on direction as below. For example, for forward direction, the final prediction signal is calculated according to Eq. (37); for backward direction, the final prediction signal is calculated according to Eq. (38); the gradient Iₓ^{k} and I_{y}^{k} can be calculated according to Eq. (39) and Eq. (40):

$$pred = \frac{{I}^{0} + {I}^{1}}{2} + \frac{1}{2} ( {v}_{x} ( {w}_{0} \cdot {I}_{x}^{0} + {w}_{1} \cdot {I}_{x}^{1} ) + {v}_{y} ( {w}_{0} \cdot {I}_{y}^{0} + {w}_{1} \cdot {I}_{y}^{1} ) ) \qquad Eq . ( 37 )$$

$$pred = \frac{{I}^{0} + {I}^{1}}{2} - \frac{1}{2} ( {v}_{x} ( {w}_{0} \cdot {I}_{x}^{0} + {w}_{1} \cdot {I}_{x}^{1} ) + {v}_{y} ( {w}_{0} \cdot {I}_{y}^{0} + {w}_{1} \cdot {I}_{y}^{1} ) ) \qquad Eq . ( 38 )$$

$${I}_{x}^{k} ( x , y ) = {I}^{k} ( x + 1 , y ) - {I}^{k} ( x - 1 , y ) \qquad Eq . ( 39 )$$

$${I}_{y}^{k} ( x , y ) = {I}^{k} ( x , y + 1 ) - {I}^{k} ( x , y - 1 ) \qquad Eq . ( 40 )$$

where I⁰ and I¹ denote the predictor from the first motion vector and second motion vector, respectively. Iₓ⁰ and I_{y}⁰ denote horizontal and vertical gradients of the nearest reference picture (e.g., first reference picture) from the current picture. Iₓ¹ and I_{y}¹ denote horizontal and vertical gradients of the second reference picture. The weights w₀ and w₁ depend on the distance between the current picture and reference pictures.

In another example, when the direction is forward and the distance between the current picture and the second reference picture is two times of the distance between the current picture and the first reference picture, the final prediction is generated according to Eq. (41). In this case, the weights (w₀, w₁) are (1, 2).

$$pred = \frac{{I}^{0} + {I}^{1}}{2} + \frac{1}{2} ( {v}_{x} ( {I}_{x}^{0} + 2 \cdot {I}_{x}^{1} ) + {v}_{y} ( {I}_{y}^{0} + 2 \cdot {I}_{y}^{1} ) ) \qquad Eq . ( 41 )$$

In another example, when the direction is backward and the distance between the current picture and second reference picture is two times of the distance between the current picture and first reference picture, the final prediction is generated according to Eq. (42). In this case, the weights (w₀, w₁) are (1, 2).

$$pred = \frac{{I}^{0} + {I}^{1}}{2} - \frac{1}{2} ( {v}_{x} ( {I}_{x}^{0} + 2 \cdot {I}_{x}^{1} ) + {v}_{y} ( {I}_{y}^{0} + 2 \cdot {I}_{y}^{1} ) ) \qquad Eq . ( 42 )$$

In some examples, UDOF can be applied in the unit of at least one of sample-wise, sub-block, and block. In an example, UDOF is applied sample by sample. In another example, UDOF is applied sub-block by sub-block. In another example, UDOF is applied CU by CU.

In some examples, UDOF can be applied according to block shape, block size, and other coding information of the block. For example, when the block size is smaller than 4×4, UDOF is not applied.

In some examples, whether UDOF is applied can be determined based on a comparison of the difference between reference blocks with a specified threshold. In an example, when the sum of absolute difference (SAD) of corresponding samples of the reference blocks is larger than a specified threshold, the UDOF is not to applied.

In another example, when the SAD cost between the two reference blocks is smaller than a specified threshold, UDOF is not applied.

In some examples, when either width or height of the current block is larger than N samples, the width and/or height of the current block can be split based on N samples. For example, when the current block size is 32×32 and N is 16, the current block can be split into 4 UDOF processing units, and each UDOF processing unit is 16×16. Further, each UDOF processing unit can be individually determined to apply or not to apply the UDOF. In some examples, whether to apply UDOF on a UDOF processing unit is determined according to the cost of reference blocks of each UDOF processing unit. In an example, the cost is calculated to indicate at least one of prediction accuracy by UDOF and complexity by UDOF.

In some examples, whether UDOF is applied can be determined by the distances between the current picture and each reference picture. For example, UDOF cannot be applied when the distance between the current picture and one reference picture is longer than the distance between the current picture and another reference picture by a threshold.

In some examples, a flag can be signalled to determine whether UDOF is applied or not. The flag can be signal at any suitable level, such as at block level, at CTU level, at slice level, in picture parameter set, in sequence parameter set and the like.

According to some aspects of the disclosure, when the weights (w₀, w₁) can be set to positive values and negative values, the UDOF equations for forward direction and backward direction can be generalized to one equation. For example, a prediction signal can be represented by Eq. (43):

$$pred = \frac{{I}^{0} + {I}^{1}}{2} + \frac{1}{2} ( {v}_{x} ( {w}_{0} \cdot {I}_{x}^{0} + {w}_{1} \cdot {I}_{x}^{1} ) + {v}_{y} ( {w}_{0} \cdot {I}_{y}^{0} + {w}_{1} \cdot {I}_{y}^{1} ) ) \qquad Eq . ( 43 )$$

where the weights (w₀, w₁) are weighting factors and are determined by the distances, such as using Eq. (44):

$${w}_{0} = \frac{P O {C}_{c u r} - P O {C}_{ref 0}}{P O {C}_{ref 1} - P O {C}_{ref 0}} , {w}_{1} = \frac{P O {C}_{c u r} - P O {C}_{ref 1}}{P O {C}_{ref 1} - P O {C}_{ref 0}} \qquad Eq . ( 44 )$$

where POC_{cur} denotes the picture order count of the current picture, POC_{ref0} denotes the picture order count of the reference picture from L0, and POC_{ref1} denotes the picture order count of the reference picture from L1. In some aspects, based on the directions (e.g., forward direction and the backward direction), and the picture order counts, the Eq, (43) can be converted to the Eq. (20), Eq. (21), Eq. (24), Eq. (25), Eq. (37), Eq. (38), Eq. (41) and Eq. (42).

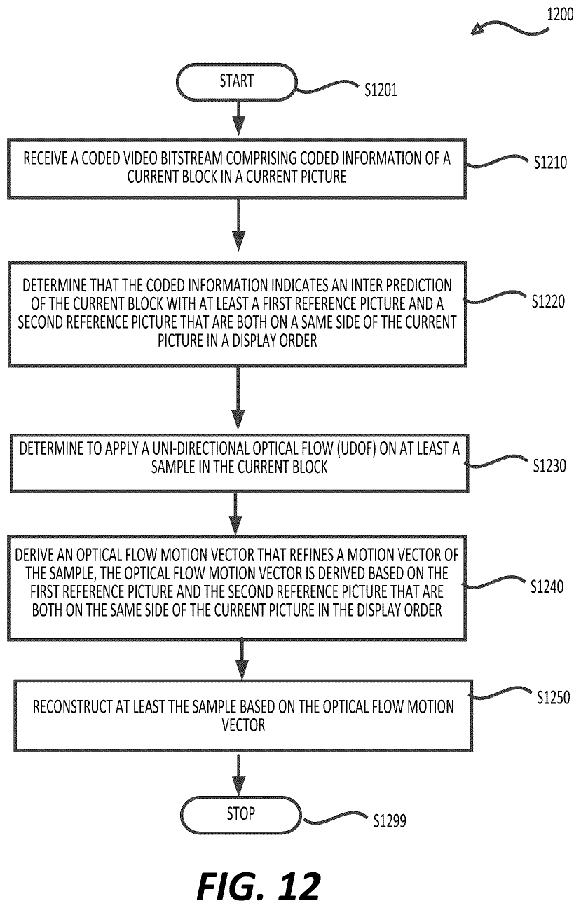

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a coded video bitstream is received. The coded video bitstream includes coded information of a current block in a current picture.

At (S1220), the coded information is determined to indicate an inter prediction of the current block with at least a first reference picture and a second reference picture that are both on a same side of the current picture in a display order.

At (S1230), to apply a uni-directional optical flow (UDOF) on at least a sample in the current block is determined.

At (S1240), an optical flow motion vector to refine a motion vector of the sample is determined. The optical flow motion vector is derived based on the first reference picture and the second reference picture that are both on the same side of the current picture in the display order.

At (S1250), at least the sample is reconstructed based on the optical flow motion vector.

In some aspects, the coded information indicates a chained motion vector that includes a first motion vector and a second motion vector in a chain, the first motion vector points to a first reference block in the first reference picture for the current block, and the second motion vector points to a second reference block in the second reference picture for the first reference block.

In some aspects, the coded information indicates a first motion vector and a second motion vector for at least the sample, the first motion vector points to a first reference sample in the first reference picture for the sample, and the second motion vector points to a second reference sample in the second reference picture for the sample.

In some examples, the first reference picture and the second reference picture are before the current picture in the display order, the UDOF is in a forward direction, and the motion vector of the sample is refined with an addition of the optical flow motion vector.

In some examples, the first reference picture and the second reference pictures are after the current picture in the display order, the UDOF is in a backward direction, and the motion vector of the sample is refined with a subtraction of the optical flow motion vector.

In some aspects, to reconstruct, an adjustment signal is calculated based on the optical flow motion vector and a weighted gradient sum of the first reference picture and the second reference picture, the weighted gradient sum is a sum of a first gradient of the first reference picture with a first weight, and a second gradient of the second reference picture of a second weight. Then, a prediction signal of the sample is generated based on a combination of a first predictor of the sample in the first reference picture, a second predictor of the sample in the second reference picture and the adjustment signal, such as Eq. (20), Eq. (21), Eq. (37) and Eq. (38).

In some examples, the optical flow motion vector includes a vertical component in a vertical direction and a horizontal component in a horizontal direction, the adjustment signal includes a first portion based on a first multiplication of the vertical component with a first weighted gradient sum in the vertical direction, and a second multiplication of the horizontal component with a second weighted gradient sum in the horizontal direction.

In some examples, wherein the first reference picture is closer to the current picture than the second reference picture, when a second distance between the current picture and the second reference picture is two times of a first distance between the current picture and the first reference picture, the second weight is two times of the first weight.

In an example, the UDOF is applied in a unit of sample-wise. In another example, the UDOF is applied in a unit of sub-block of the current block. In another example, the UDOF is applied in a unit of the current block.

In some examples, the UDOF is applied according to at least one of a block size of the current block and a block shape of the current block.

In some aspects, to apply the UDOF is determined based on a difference of a first reference block of the current block in the first reference picture and a second reference block of the current block in the second reference picture.

In some aspects, the current block is split into multiple UDOF processing units when at least one of a width of the current block and a height of the current block is larger than a limit. For each UDOF processing unit of the multiple UDOF processing units, whether to apply the UDOF to the UDOF processing unit is determined.

In some examples, a cost value associated with the UDOF processing unit is calculated. The cost value indicates at least one of an accuracy of applying the UDOF on the UDOF processing unit and a complexity of applying the UDOF on the UDOF processing unit. Whether to apply the UDOF to the UDOF processing unit is determined based on the cost value.

In some aspects, to apply the UDOF is determined based on a first distance between the current block and the first reference picture and a second distance between the current block and the second reference picture. In an example, not to apply the UDOF is determined when a difference of the first distance and the second distance is larger than a threshold.

In some examples, a value of a syntax element is decoded from the coded video bitstream. Whether to apply the UDOF is determined based on the value of the syntax element.

Then, the process proceeds to (S1299) and terminates.

The process (1200) can be suitably adapted. Step(s) in the process (1200) can be modified and/or omitted. Additional step(s) can be added. Any suitable order of implementation can be used.

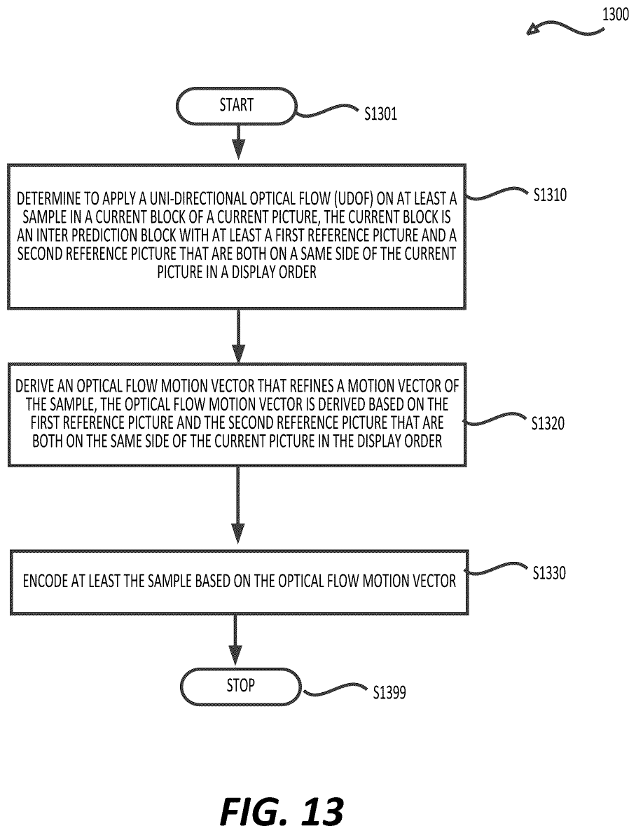

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), to apply a uni-directional optical flow (UDOF) on at least a sample in a current block of a current picture is determined. The current block is an inter prediction block with at least a first reference picture and a second reference picture that are both on a same side of the current picture in a display order.

At (S1320), an optical flow motion vector that refines a motion vector of the sample is derived. The optical flow motion vector is derived based on the first reference picture and the second reference picture that are both on the same side of the current picture in the display order.

At (S1330), at least the sample is encoded based on the optical flow motion vector.

In some aspects, the current block includes a chained motion vector that includes a first motion vector and a second motion vector in a chain, the first motion vector points to a first reference block in the first reference picture for the current block, and the second motion vector points to a second reference block in the second reference picture for the first reference block.

In some aspects, the current block includes a first motion vector and a second motion vector for at least the sample, the first motion vector points to a first reference sample in the first reference picture for the sample, and the second motion vector points to a second reference sample in the second reference picture for the sample.

In some aspects, the first reference picture and the second reference picture are before the current picture in the display order, the UDOF is in a forward direction, and the motion vector of the sample is refined with an addition of the optical flow motion vector.

In some aspects, the first reference picture and the second reference pictures are after the current picture in the display order, the UDOF is in a backward direction, and the motion vector of the sample is refined with a subtraction of the optical flow motion vector.

In some aspects, to encode, an adjustment signal is calculated based on the optical flow motion vector and a weighted gradient sum of the first reference picture and the second reference picture, the weighted gradient sum is a sum of a first gradient of the first reference picture with a first weight, and a second gradient of the second reference picture of a second weight. Also, a prediction signal of the sample is generated based on a combination of a first predictor of the sample in the first reference picture, a second predictor of the sample in the second reference picture and the adjustment signal, such as Eq. (20), Eq. (21), Eq. (37) and Eq. (38).

In some examples, the optical flow motion vector includes a vertical component in a vertical direction and a horizontal component in a horizontal direction, the adjustment signal includes a first portion based on a first multiplication of the vertical component with a first weighted gradient sum in the vertical direction, and a second multiplication of the horizontal component with a second weighted gradient sum in the horizontal direction.

In some examples, the first reference picture is closer to the current picture than the second reference picture, when a second distance between the current picture and the second reference picture is two times of a first distance between the current picture and the first reference picture, the second weight is two times of the first weight.

In an example, the UDOF is applied in a unit of sample-wise. In another example, the UDOF is applied in a unit of a sub-block of the current block. In another example, the UDOF is applied in a unit of the current block.

In some examples, to apply the UDOF is determined according to at least one of a block size of the current block and a block shape of the current block.

In some examples, to apply the UDOF is determined based on a difference of a first reference block of the current block in the first reference picture and a second reference block of the current block in the second reference picture.

In some aspects, the current block is split into multiple UDOF processing units when at least one of a width of the current block and a height of the current block is larger than a limit. For each UDOF processing unit of the multiple UDOF processing units, whether to apply the UDOF to the UDOF processing unit is determined.

In some aspects, a cost value associated with the UDOF processing unit is calculated. The cost value indicating at least one of an accuracy of applying the UDOF on the UDOF processing unit and a complexity of applying the UDOF on the UDOF processing unit. Whether to apply the UDOF to the UDOF processing unit is determined based on the cost value.

In some examples, to apply the UDOF is determined based on a first distance between the current block and the first reference picture and a second distance between the current block and the second reference picture. In an example, not to apply the UDOF is determined when a difference of the first distance and the second distance is larger than a threshold.

In some examples, coded information of the current block and a flag indicative of an application of the UDOF is included in a coded video bitstream.

Then, the process proceeds to (S1399) and terminates.

The process (1300) can be suitably adapted. Step(s) in the process (1300) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one o more constraints of the bitstream and/or one or more processes to be performed by the decoder and/or encoder.

In an example, the bitstream includes coded information of a current block in a current picture, the coded information of the current block indicates an inter prediction of the current block with at least a first reference picture and a second reference picture that are both on a same side of the current picture in a display order. The format rule specifies that: to apply a uni-directional optical flow (UDOF) on at least a sample in the current block is determined; an optical flow motion vector that refines a motion vector of the sample is derived based on the first reference picture and the second reference picture that are both on the same side of the current picture in the display order; and at least the sample is reconstructed based on the optical flow motion vector.

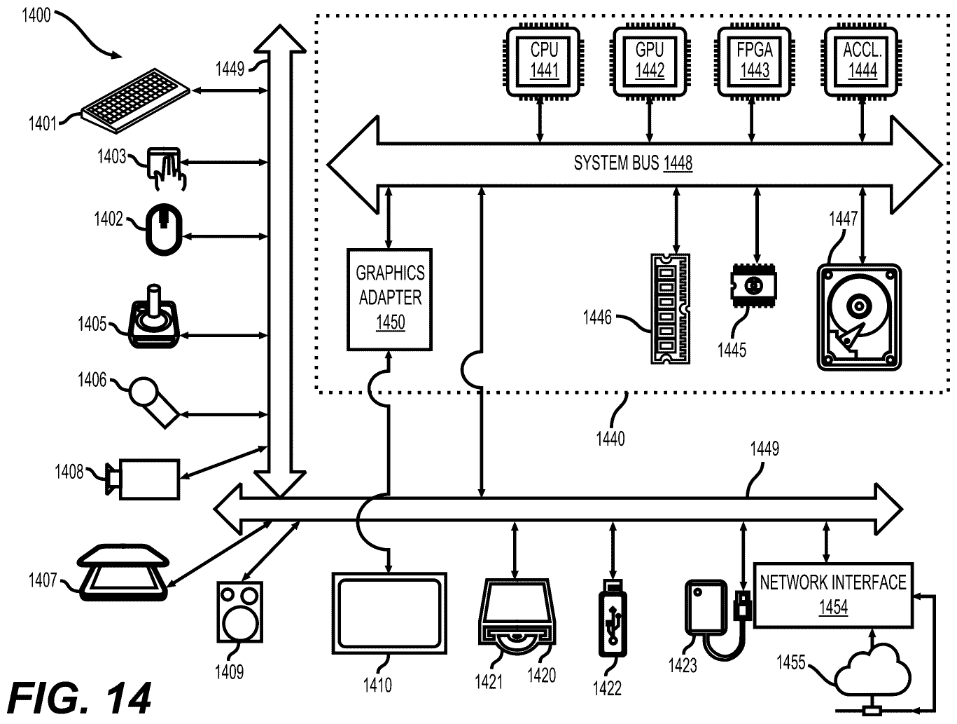

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of video decoding, including: receiving a coded video bitstream including coded information of a current block in a current picture; determining that the coded information indicates an inter prediction of the current block with at least a first reference picture and a second reference picture that are both on a same side of the current picture in a display order; determining to apply a uni-directional optical flow (UDOF) on at least a sample in the current block; deriving an optical flow motion vector that refines a motion vector of the sample, the optical flow motion vector being derived based on the first reference picture and the second reference picture that are both on the same side of the current picture in the display order; and reconstructing at least the sample based on the optical flow motion vector.
(2). The method of feature (1), in which the coded information indicates a chained motion vector that includes a first motion vector and a second motion vector in a chain, the first motion vector points to a first reference block in the first reference picture for the current block, and the second motion vector points to a second reference block in the second reference picture for the first reference block.
(3). The method of any of features (1) to (2), in which the coded information indicates a first motion vector and a second motion vector for at least the sample, the first motion vector points to a first reference sample in the first reference picture for the sample, and the second motion vector points to a second reference sample in the second reference picture for the sample.
(4). The method of any of features (1) to (3), in which the first reference picture and the second reference picture are before the current picture in the display order, the UDOF is in a forward direction, and the motion vector of the sample is refined with an addition of the optical flow motion vector.
(5). The method of any of features (1) to (4), in which the first reference picture and the second reference pictures are after the current picture in the display order, the UDOF is in a backward direction, and the motion vector of the sample is refined with a subtraction of the optical flow motion vector.
(6). The method of any of features (1) to (5), in which the reconstructing includes: calculating an adjustment signal based on the optical flow motion vector and a weighted gradient sum of the first reference picture and the second reference picture, the weighted gradient sum being a sum of a first gradient of the first reference picture with a first weight, and a second gradient of the second reference picture of a second weight; and generating a prediction signal of the sample based on a combination of a first predictor of the sample in the first reference picture, a second predictor of the sample in the second reference picture and the adjustment signal.
(7). The method of any of features (1) to (6), in which the optical flow motion vector includes a vertical component in a vertical direction and a horizontal component in a horizontal direction, the adjustment signal includes a first portion based on a first multiplication of the vertical component with a first weighted gradient sum in the vertical direction, and a second multiplication of the horizontal component with a second weighted gradient sum in the horizontal direction.
(8). The method of any of features (1) to (7), in which the first reference picture is closer to the current picture than the second reference picture, when a second distance between the current picture and the second reference picture is two times of a first distance between the current picture and the first reference picture, the second weight is two times of the first weight.
(9). The method of any of features (1) to (8), in which the determining to apply the UDOF includes at least one of: determining to apply the UDOF in a unit of sample-wise; determining to apply the UDOF in a unit of sub-block of the current block; and determining to apply the UDOF in a unit of the current block.
(10). The method of any of features (1) to (9), in which the determining to apply the UDOF includes: determining to apply the UDOF according to at least one of a block size of the current block and a block shape of the current block.
(11). The method of any of features (1) to (10), in which the determining to apply the UDOF includes: determining to apply the UDOF based on a difference of a first reference block of the current block in the first reference picture and a second reference block of the current block in the second reference picture.
(12). The method of any of features (1) to (11), in which the determining to apply the UDOF includes: splitting the current block into multiple UDOF processing units when at least one of a width of the current block and a height of the current block is larger than a limit; and determining for each UDOF processing unit of the multiple UDOF processing units whether to apply the UDOF to the UDOF processing unit.
(13). The method of any of features (1) to (12), in which the determining whether to apply the UDOF to the UDOF processing unit further includes: calculating a cost value associated with the UDOF processing unit, the cost value indicating at least one of an accuracy of applying the UDOF on the UDOF processing unit and a complexity of applying the UDOF on the UDOF processing unit; and determining whether to apply the UDOF to the UDOF processing unit based on the cost value.
(14). The method of any of features (1) to (13), in which the determining to apply the UDOF includes: determining to apply the UDOF based on a first distance between the current block and the first reference picture and a second distance between the current block and the second reference picture.
(15). The method of any of features (1) to (14), in which the determining to apply the UDOF includes: determining not to apply the UDOF when a difference of the first distance and the second distance is larger than a threshold.
(16). The method of any of features (1) to (15), in which the determining to apply the UDOF includes: decoding a value of a syntax element from the coded video bitstream; and determining whether to apply the UDOF based on the value of the syntax element.
(17). A method of video encoding, including: determining to apply a uni-directional optical flow (UDOF) on at least a sample in a current block of a current picture, the current block being an inter prediction block with at least a first reference picture and a second reference picture that are both on a same side of the current picture in a display order; deriving an optical flow motion vector that refines a motion vector of the sample, the optical flow motion vector being derived based on the first reference picture and the second reference picture that are both on the same side of the current picture in the display order; and encoding at least the sample based on the optical flow motion vector.
(18). The method of feature (17), in which the current block includes a chained motion vector that includes a first motion vector and a second motion vector in a chain, the first motion vector points to a first reference block in the first reference picture for the current block, and the second motion vector points to a second reference block in the second reference picture for the first reference block.
(19). The method of any of features (17) to (18), in which the current block includes a first motion vector and a second motion vector for at least the sample, the first motion vector points to a first reference sample in the first reference picture for the sample, and the second motion vector points to a second reference sample in the second reference picture for the sample.
(20). The method of any of features (17) to (19), in which the first reference picture and the second reference picture are before the current picture in the display order, the UDOF is in a forward direction, and the motion vector of the sample is refined with an addition of the optical flow motion vector.
(21). The method of any of features (17) to (20), in which the first reference picture and the second reference pictures are after the current picture in the display order, the UDOF is in a backward direction, and the motion vector of the sample is refined with a subtraction of the optical flow motion vector.
(22). The method of any of features (17) to (21), in which the encoding includes: calculating an adjustment signal based on the optical flow motion vector and a weighted gradient sum of the first reference picture and the second reference picture, the weighted gradient sum being a sum of a first gradient of the first reference picture with a first weight, and a second gradient of the second reference picture of a second weight; and generating a prediction signal of the sample based on a combination of a first predictor of the sample in the first reference picture, a second predictor of the sample in the second reference picture and the adjustment signal.
(23). The method of any of features (17) to (22), in which the optical flow motion vector includes a vertical component in a vertical direction and a horizontal component in a horizontal direction, the adjustment signal includes a first portion based on a first multiplication of the vertical component with a first weighted gradient sum in the vertical direction, and a second multiplication of the horizontal component with a second weighted gradient sum in the horizontal direction.
(24). The method of any of features (17) to (23), in which the first reference picture is closer to the current picture than the second reference picture, when a second distance between the current picture and the second reference picture is two times of a first distance between the current picture and the first reference picture, the second weight is two times of the first weight.
(25). The method of any of features (17) to (24), in which the determining to apply the UDOF includes at least one of: determining to apply the UDOF in a unit of sample-wise; determining to apply the UDOF in a unit of a sub-block of the current block; and determining to apply the UDOF in a unit of the current block.
(26). The method of any of features (17) to (25), in which the determining to apply the UDOF includes: determining to apply the UDOF according to at least one of a block size of the current block and a block shape of the current block.
(27). The method of any of features (17) to (26), in which the determining to apply the UDOF includes: determining to apply the UDOF based on a difference of a first reference block of the current block in the first reference picture and a second reference block of the current block in the second reference picture.
(28). The method of any of features (17) to (27), in which the determining to apply the UDOF includes: splitting the current block into multiple UDOF processing units when at least one of a width of the current block and a height of the current block is larger than a limit; and determining for each UDOF processing unit of the multiple UDOF processing units whether to apply the UDOF to the UDOF processing unit.
(29). The method of any of features (17) to (28), in which the determining whether to apply the UDOF to the UDOF processing unit further includes: calculating a cost value associated with the UDOF processing unit, the cost value indicating at least one of an accuracy of applying the UDOF on the UDOF processing unit and a complexity of applying the UDOF on the UDOF processing unit; and determining whether to apply the UDOF to the UDOF processing unit based on the cost value.
(30). The method of any of features (17) to (29), in which the determining to apply the UDOF includes: determining to apply the UDOF based on a first distance between the current block and the first reference picture and a second distance between the current block and the second reference picture.
(31). The method of any of features (17) to (30), in which the determining to apply the UDOF includes: determining not to apply the UDOF when a difference of the first distance and the second distance is larger than a threshold.
(32). The method of any of features (17) to (31), in which the encoding includes: including coded information of the current block and a flag indicative of an application of the UDOF.
(33). A method of processing visual media data, the method including: processing a bitstream of visual media data according to a format rule, in which: the bitstream includes coded information of a current block in a current picture, the coded information of the current block indicating an inter prediction of the current block with at least a first reference picture and a second reference picture that are both on a same side of the current picture in a display order; and the format rule specifies that: to apply a uni-directional optical flow (UDOF) on at least a sample in the current block is determined; an optical flow motion vector that refines a motion vector of the sample is derived based on the first reference picture and the second reference picture that are both on the same side of the current picture in the display order; and at least the sample is reconstructed based on the optical flow motion vector.
(34). An apparatus for video decoding, including processing circuitry that is configured to perform the method of any of features (1) to (16).
(35). An apparatus for video encoding, including processing circuitry that is configured to perform the method of any of features (17) to (32).
(36). A non-transitory computer-readable storage medium storing instructions which when executed by at least one processor cause the at least one processor to perform the method of any of features (1) to (33).

What is claimed is:

1. A method of video decoding, comprising:
receiving a coded video bitstream comprising coded information of a current block in a current picture;
determining that the coded information indicates an inter prediction of the current block with at least a first reference picture and a second reference picture that are both on a same side of the current picture in a display order;
determining to apply a uni-directional optical flow (UDOF) on at least a sample in the current block;
deriving an optical flow motion vector that refines a motion vector of the sample, the optical flow motion vector being derived based on the first reference picture and the second reference picture that are both on the same side of the current picture in the display order; and
reconstructing at least the sample based on the optical flow motion vector.

2. The method of claim 1, wherein the coded information indicates a chained motion vector that includes a first motion vector and a second motion vector in a chain, the first motion vector points to a first reference block in the first reference picture for the current block, and the second motion vector points to a second reference block in the second reference picture for the first reference block.

3. The method of claim 1, wherein the coded information indicates a first motion vector and a second motion vector for at least the sample, the first motion vector points to a first reference sample in the first reference picture for the sample, and the second motion vector points to a second reference sample in the second reference picture for the sample.

4. The method of claim 1, wherein the first reference picture and the second reference picture are before the current picture in the display order, the UDOF is in a forward direction, and the motion vector of the sample is refined with an addition of the optical flow motion vector.

5. The method of claim 1, wherein the first reference picture and the second reference pictures are after the current picture in the display order, the UDOF is in a backward direction, and the motion vector of the sample is refined with a subtraction of the optical flow motion vector.

6. The method of claim 1, wherein the reconstructing comprises:
calculating an adjustment signal based on the optical flow motion vector and a weighted gradient sum of the first reference picture and the second reference picture, the weighted gradient sum being a sum of a first gradient of the first reference picture with a first weight, and a second gradient of the second reference picture of a second weight; and
generating a prediction signal of the sample based on a combination of a first predictor of the sample in the first reference picture, a second predictor of the sample in the second reference picture and the adjustment signal.

7. The method of claim 6, wherein the optical flow motion vector includes a vertical component in a vertical direction and a horizontal component in a horizontal direction, the adjustment signal includes a first portion based on a first multiplication of the vertical component with a first weighted gradient sum in the vertical direction, and a second multiplication of the horizontal component with a second weighted gradient sum in the horizontal direction.

8. The method of claim 6, wherein the first reference picture is closer to the current picture than the second reference picture, when a second distance between the current picture and the second reference picture is two times of a first distance between the current picture and the first reference picture, the second weight is two times of the first weight.

9. The method of claim 1, wherein the determining to apply the UDOF comprises at least one of:
determining to apply the UDOF in a unit of sample-wise;
determining to apply the UDOF in a unit of sub-block of the current block; and
determining to apply the UDOF in a unit of the current block.

10. The method of claim 1, wherein the determining to apply the UDOF comprises:
determining to apply the UDOF according to at least one of a block size of the current block and a block shape of the current block.

11. The method of claim 1, wherein the determining to apply the UDOF comprises:
determining to apply the UDOF based on a difference of a first reference block of the current block in the first reference picture and a second reference block of the current block in the second reference picture.

12. The method of claim 1, wherein the determining to apply the UDOF comprises:
splitting the current block into multiple UDOF processing units when at least one of a width of the current block and a height of the current block is larger than a limit; and
determining for each UDOF processing unit of the multiple UDOF processing units whether to apply the UDOF to the UDOF processing unit.

13. The method of claim 12, wherein the determining whether to apply the UDOF to the UDOF processing unit further comprises:
calculating a cost value associated with the UDOF processing unit, the cost value indicating at least one of an accuracy of applying the UDOF on the UDOF processing unit and a complexity of applying the UDOF on the UDOF processing unit; and
determining whether to apply the UDOF to the UDOF processing unit based on the cost value.

14. The method of claim 1, wherein the determining to apply the UDOF comprises:
determining to apply the UDOF based on a first distance between the current block and the first reference picture and a second distance between the current block and the second reference picture.

15. The method of claim 14, wherein the determining to apply the UDOF comprises:
determining not to apply the UDOF when a difference of the first distance and the second distance is larger than a threshold.

16. The method of claim 1, wherein the determining to apply the UDOF comprises:
decoding a value of a syntax element from the coded video bitstream; and
determining whether to apply the UDOF based on the value of the syntax element.

17. A method of video encoding, comprising:
determining to apply a uni-directional optical flow (UDOF) on at least a sample in a current block of a current picture, the current block being an inter prediction block with at least a first reference picture and a second reference picture that are both on a same side of the current picture in a display order;
deriving an optical flow motion vector that refines a motion vector of the sample, the optical flow motion vector being derived based on the first reference picture and the second reference picture that are both on the same side of the current picture in the display order; and
encoding at least the sample based on the optical flow motion vector.

18. The method of claim 17, wherein the current block includes a chained motion vector that includes a first motion vector and a second motion vector in a chain, the first motion vector points to a first reference block in the first reference picture for the current block, and the second motion vector points to a second reference block in the second reference picture for the first reference block.

19. The method of claim 17, wherein the current block includes a first motion vector and a second motion vector for at least the sample, the first motion vector points to a first reference sample in the first reference picture for the sample, and the second motion vector points to a second reference sample in the second reference picture for the sample.

20. A method of processing visual media data, the method comprising:
processing a bitstream of visual media data according to a format rule, wherein:
the bitstream includes coded information of a current block in a current picture, the coded information of the current block indicating an inter prediction of the current block with at least a first reference picture and a second reference picture that are both on a same side of the current picture in a display order; and
the format rule specifies that:
to apply a uni-directional optical flow (UDOF) on at least a sample in the current block is determined;
an optical flow motion vector that refines a motion vector of the sample is derived based on the first reference picture and the second reference picture that are both on the same side of the current picture in the display order; and
at least the sample is reconstructed based on the optical flow motion vector.
